(19) United States
(12) Patent Application Publication
(10) Pub. No.: US 2006/0244839 A1
(43) Pub. Date: Nov. 2, 2006

(54) Method and system for providing multi-media data from various sources to various client applications

(75) Inventors: Arnaud Glatron, Santa Clara, CA (US); Aaron Standridge, Newark, CA (US); Tim Dieckman, San Francisco, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Logitech Europe S.A., Romanel-sur-Morges (CH)

(21) Appl. No.: 11/321,978

(22) Filed: Dec. 28, 2005

Related U.S. Application Data
(63) Continuation-in-part of application No. 11/180,313, filed on Jul. 12, 2005.
Application No. 11/180,313 is a continuation of application No. 09/882,527, filed on Jun. 15, 2001, now Pat. No. 6,918,118.
Application No. 09/882,527 is a continuation-in-part of application No. 09/438,012, filed on Nov. 10, 1999, now Pat. No. 6,539,441.

(51) Int. Cl. H04N 5/225; H04N 5/232; H04N 7/173; H04N 7/16

(52) U.S. Cl. 348/211.11; 725/135; 725/100; 725/132; 348/207.11

(57) ABSTRACT

The present invention seamlessly enables a single media stream to be exposed to as many clients/applications as desired, in a manner that is completely transparent to the client/application. Further, an embodiment of the present invention combines media streams from multiple devices (e.g., webcams, microphones, etc.) into a single virtual stream that can then be accessed by as many clients as desired. In some embodiments of the above invention, each client can request a different format and frame rate. Further, in some embodiments of the present invention, the ability to provide media data from one or more sources to one or more client applications is completely transparent to the applications, as well as to the users.

### CROSS-REFERENCES TO RELATED APPLICATIONS

This application is a continuation in part (“CIP”) of application Ser. No. 11/180,313, entitled “Multi-Instance Input Device Control” filed on Jul. 12, 2005, which is in turn a continuation of application Ser. No. 09/882,527, filed Jun. 15, 2001, now U.S. Pat. No. 6,918,118, which is a continuation of application Ser. No. 09/438,012, filed Nov. 10, 1999, for MULTI INSTANCE INPUT DEVICE CONTROL, now U.S. Pat. No. 6,539,441. All of these patents/applications are incorporated herein in their entirety.

### BACKGROUND OF THE INVENTION

The present invention relates to media source input devices such as microphones and video cameras, and in particular to the interfacing of media source input devices to application programs.

Traditionally, when one application program connects to a media source, all other application programs are prevented from using that media source. In the context of a common personal computer, when an application program calls to communicate with a media source, the application program calls to the driver files or the dynamic link library (DLL or *.dll) files. Typically, a DLL provides one or more particular functions and a program accesses the function by creating a link to the DLL. DLL's can also contain data. Some DLL's are provided with the operating system (such as the Windows operating system) and are available for any operating system application. Other DLL's are written for a particular application and are loaded with the application program (such a media source control application program). When a media source control application program calls to connect to a media source, at that point, the driver checks to make sure that no other application has opened the particular camera driver file (*.dll), and if no other has, the driver will open the particular driver file. Having done so, there now exists a single threaded connection between the media source (e.g., video camera) and the application program through the opened media source (e.g., video camera) driver file as seen in FIG. 1.

FIG. 1 shows an application program connecting with a media source, which is a video camera. As depicted in FIG. 1, the driver file 14 is opened by the driver 12 which is called by the calling application program 10 and gets loaded in the calling application program's memory. Since the video camera driver file 14 has been opened by the application program 10, the next application that attempts to make a call to the video camera is prevented from doing so. The issues related to conflicts in sharing a media source between multiple application programs is known as contingency issues. There will be contingency issues, since typical input device drivers only allow one application to use the input device data at any given time. This is because the video camera driver file has been loaded in the first application program's memory and is not available to be accessed by another calling program. Therefore, each application program that potentially makes calls to a video camera must account for the presence of another application program possibly already using the camera. Accordingly, such application programs are encumbered by the need to first check to determine whether another first application program was executed that had connected to the video camera, and if so the second calling program must have routines allowing it to negotiate the sharing of the camera. However such sharing is a single-instant one, meaning the that connection between the camera and the first application program would have to be broken ( i.e. the first application program would have to be shut down or the video camera turned off) before the connection between camera and the second application program could be established. Authority, priority, and other security aspects as well as appropriate error handling must also be resolved by the communications between the two competing application programs. Presently, no application program even attempts to resolve any of these issues, and therefore if a connection between a calling program and a camera cannot be established, the unexpected application programs errors are resolved by the operating system which issues rather inelegant and undecipherable error messages leaving the ultimate user to only infer that a proper connection could not be established. At best, the second calling application program receives a message that the device being called to is currently in use and not available.

Application programs have continued to grow in size, flexibility and usability, and the trend has been to move away from large monolithic application programs to programs that are made of many smaller sub-programs. This building block approach provides many advantages such as ease of later modification and configurability. Moreover, operating system suppliers, such as Microsoft, have also adopted such a modular approach and hence offer many standard sub-programs or objects that handle many utility-type functions such as queuing files to a printer, and loading and running printer driver (e.g., DLL) files to print files. The driver (e.g., DLL) files themselves are objects or sub-programs. Further, in an effort to allow interoperability between objects and smaller sub-programs written in different high level programming languages, operating systems suppliers have developed models for executable programs, which can be compatible with each other at the binary level. One such model for binary code developed by the Microsoft Corporation is the component object model (COM). The COM enables programmers to develop objects that can be accessed by any COM-compliant application. Although many benefits can be realized by transitioning from large monolithic application programs to sets of smaller sub-programs and objects, those advantages must be balanced against the burdens imposed by the need for the additional routines allowing for inter process communications amongst these sub-programs and objects.

Besides growing in complexity and usability, multi-unit application programs have been migrating from single-host sites to multiple host heterogeneous network environments. Consequently, it is now not unheard of to have a single application program be comprised of many different routines, each written in different high level programming languages and each residing on a separate computer, where all those computers are connected to each other across a network. In such implementations, the demands for efficient intra and inter-network and inter-process communications can take on a life of their own, detracting from the programmer's primary function of writing an application program. The programmer also has to handle the communications issues posed by spreading application programs across a network. Once again, operating systems suppliers have realized this challenge and potential detraction and have addressed it in various ways. For example, Microsoft has extended the COM functionality by developing the distributed component object model (DCOM). DCOM is an extension of COM to support objects distributed across a network. Besides being an extension of COM, DCOM provides an interface that handles the details of network communication protocols allowing application programmers to focus on their primary function of developing application specific programs. DCOM is designed to address the enterprise requirements for distributed component architecture. For example, a business may want to build and deploy a customer order entry application that involves several different areas of functionality such as tax calculation, customer credit verification, inventory management, warranty update and order entry. Using DCOM the application may be built from five separate components and operated on a web server with access via a browser. Each component can reside on a different computer accessing a different database. The programmer can focus on application development and DCOM is there to handle the inter process communications aspects of the separate components of the application program. For example, DCOM would handle the integration of component communication with appropriate queues and the integration of component applications on a server with HTML-based Internet applications.

Thus, while many computer system operating system suppliers are providing many standardized models for executable programs, even such executable programs can only interface with a media source input device on a one-on-one basis. A standardized device driver file, once linked to an application program, is no longer available for use by another program.

Some webcam suppliers (e.g., Creative Labs from Singapore) use the concept of virtual sources, but this is done by presenting the user with a choice of multiple devices to select from. For instance, a user will see the “regular webcam, as well as a “virtual” webcam. If the user selects the “regular” webcam, she will not be able to use certain video effects. However, the user can do so if she chooses to use the “virtual” webcam. This necessitates unnecessary user intervention, and possibly user confusion. Further, this does not address the issue of providing-video data from one source to multiple client applications at the same time.

Further, multiple sources cannot currently be seamless virtualized into a single source in a generalized manner. There are some known applications (e.g., surveillance systems) where media data from various sources can be output in a combined manner. However, this can only be done by acquiring and using specialized and expensive hardware, or in the context of specific software applications (e.g., with specific APIs). Thus there does not exist a simple solution to combine media data from various sources into a single source, without the use of special hardware, and which can be used with any application.

Windows 2000 included a kernel-mode Windows Driver Module for virtual audio. The clients communicated with the virtual audio source instead of the actual source. Multiple clients could receive an audio stream from the same audio source. Also, a mixer system driver is provided. This virtualization of sources by Microsoft is limited to audio, and also does not permit multiple audio sources to be virtualized for providing data to one or more client applications.

There is a need to allow multiple application programs to share a single media source input device (which most commonly is a video camera or microphone), in an easy and seamless way, without the user needing to actively choose a virtual device in order to accomplish this. Further, there is a need to allow media data from multiple sources to be combined into a single stream, which can then be used by one or multiple application programs, in a generalized and transparent way, and without the need for any specialized hardware.

### SUMMARY OF THE INVENTION

The present invention combines features of an executable process with the need for multiple application programs to share a single input device, such as video camera or a microphone. An input device such as a video camera or a microphone is a peripheral device that is opened and remains open in response to a call from an application programs. The present invention provides an executable program implemented as a process that allows multiple applications to communicate with a single input device. This is achieved by creating a virtual interface (an instance) to the physical input device and by loading the input device control executable program into a process. An instance is an actual usage and the resulting virtual creation of a copy of an entity loaded into memory. The executable program process acts as a server thus allowing multiple application programs to interface with the same input device. This executable program, which as used herein is referred to as the multi-instance input device control (MIIDC) executable program responds to each application program request as if the input device is open for the calling application program. Each application program is thus enabled to communicate with the input device instance without interrupting the operation of other application programs communicating with the same input device. In other words, the MIIDC virtualizes an input device by creating s client-server architecture, where each calling application program is a client and where the MIIDC is the server, serving the driver file to each calling application program.

The MIIDC and the method of virtualizing an input device are implementable on many computing platforms running various operating systems. A media source input device such as a video camera or a microphone is commonly interfaced with a host computer. The host computer is most commonly a personal computer, such as the commonly available PC of Mac computers. However, since advancements in technology are blurring the boundaries between computing and communication devices, a host computer as used herein is synonymous with an intelligent host, and an intelligent host as used herein is meant to include other examples of any host having a processor, memory, means for input and output, and means for storage. Other examples of intelligent hosts, which are also equally qualified to be used in conjunction with embodiments of the present invention include a handheld computer, an interactive set-top box, a thin client computing device, a personal access device, a personal digital assistants, and an internet appliance.

In one implementation on a PC host running a common Windows-based operating system, the (MIIDC) executable program can be a DCOM object. DCOM can also serve as an interface that allows multiple application programs to communicate with a single input device. The DCOM interface handles all interfacing operations such as: loading, executing, buffering, unloading and calling to the executable program. In the DCOM-based implementation, the MIIDC object itself is a DCOM server. The MIIDC program works by connecting to the input device in a DCOM object implemented as an executable server. Consequently, the MIIDC becomes a DCOM object implemented as an executable program, meaning that MIIDC is a process—like any other operating system (O/S) process—sharable by many applications. By placing the input device access program into a separate executable process, the input device is capable of being shared by multiple application programs. The DCOM interface appears to the application program as if it is being opened just for the application that calls to the DCOM object, while there's only one instance of the input device.

MIIDC is implemented so that for each actual hardware input device, the DCOM server creates a single input device instance and connects to the hardware device. When an application program connects with the input device control—which is an executable DCOM server—the DCOM server creates a MIIDC instance (and an interface) through which the application program communicates with the single input device instance. Data is provided for output by the single input device instance for each instance of the input device control, thus allowing simultaneous multiple applications to communicate with a single input device. Global settings are (MIIDC) instance specific. Additionally, the input device instance is protected so that multiple instances of the input device control program cannot perform tasks that would interfere with processing in another instance. Using this new approach, applications can be written which do not need to account for the presence of another application possibly already using the same input device.

Other aspects of the present invention are directed towards the client-side mechanisms that enable an application program to communicate with the input device server executable. As described above, the MIIDC executable is implemented under a client-server architecture, where each application program is a client. Naturally, a client must be able to communicate with the server. The method of the present invention provides several mechanisms that enable an application program to communicate with the MIIDC server. In a PC/Windows environment, a first client-side mechanism is delivered via an ActiveX control called an input device portal. A second client-side mechanism also under a PC/Windows environment, is delivered via a DirectShow™ video capture source filter.

The client side mechanisms under the portal approach include communicating with the MIIDC server and supplying user-interface elements to an application. With the portal approach, all functionality of virtualizing an input device is performed by the MIIDC server, and thus, application programs communicating with the MIIDC server will require user-interface programming. To accomplish this, under the video-portal approach, a template is provided to allow various application program providers to generate their own custom input-device portal.

The client-side mechanism under the second approach (i.e. DirectShow approach) takes advantage of the standardized DirectShow modular components called filters. This second client-side mechanism replaces the standard source (media input) filter with a virtual source filter, which communicated directly with the MIIDC server. The virtual source filter is a client to the MIIDC server. With this mechanism, a DirectShow application cannot distinguish between the “real” and the “virtual” source filter. The advantage of this second client-side mechanism is that any application program written to function in a DirectShow environment, will be able to readily share an input device without the need for any additional user-interface programming before being able to communicate with the MIIDC server.

A system in accordance with one embodiment of the present invention seamlessly enables a single video stream to be exposed to as many clients/applications as desired, in a manner that is completely transparent to the client/application. Further, in one embodiment, a system in accordance with an embodiment of the present invention combines video streams from multiple devices into a single virtual stream that can then be accessed by as many clients as desired. In some embodiments of the above invention, each client can request a different format and frame rate. Further, in some embodiments of the present invention, the ability to provide media data from one or more sources to one or more client applications is completely transparent to the applications themselves. In addition, in a system in accordance with some embodiments of the present invention, this implementation is also transparent to the users, in that the users do not need to choose any specific virtual device etc. in order to obtain such functionality.

For a further understanding of the nature and advantages of the present invention, reference should be made to the following description in conjunction with the accompanying drawings.

### BRIEF DESCRIPTION OF THE DRAWINGS

FIG. 1 is a block diagram showing the prior art method of a single application program communicating with a single video camera device.

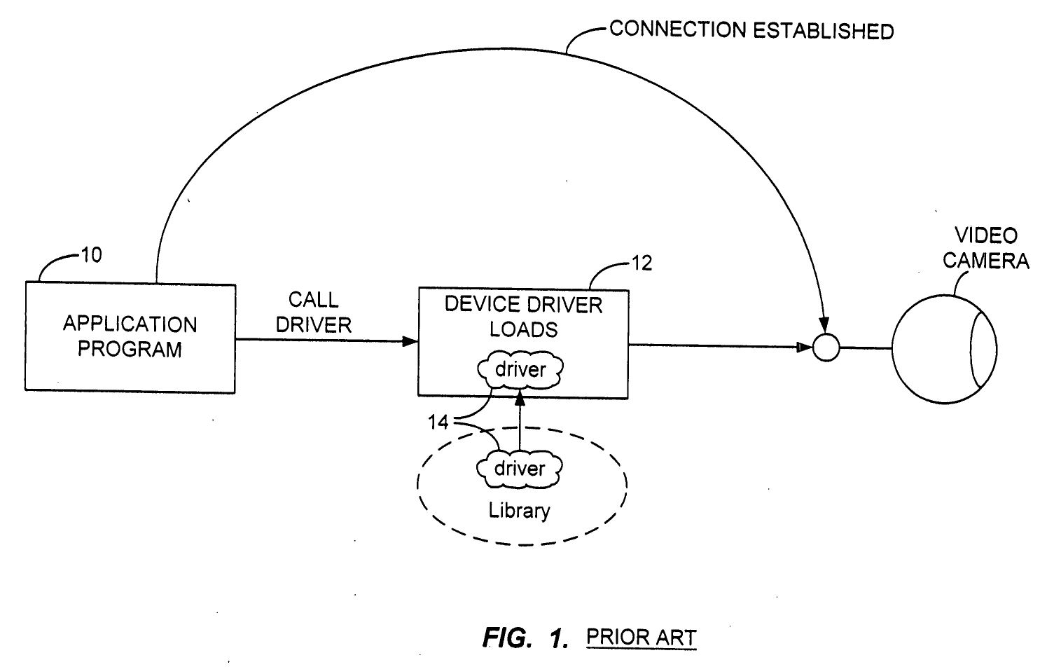

FIG. 2 is a block diagram depicting one embodiment of the present multi-instance input device control program.

FIG. 3 is a flow chart showing the steps involved in an application connecting to a single input device.

FIG. 4 is a block diagram illustrating one embodiment of the present invention, in which multiple sources can communicate with multiple applications.

### DESCRIPTION OF THE SPECIFIC EMBODIMENTS

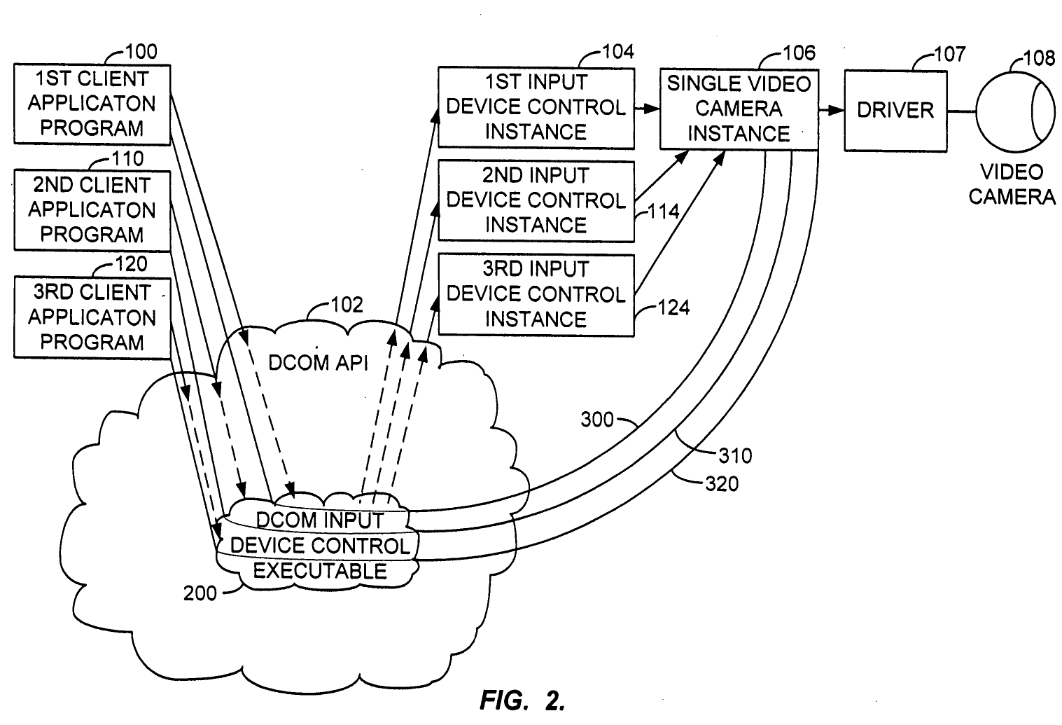

FIG. 2 shows a block diagram depicting one embodiment of the present multi-instance input device control program (MIIDC) in a PC/Windows environment. In this embodiment, the input device is a video camera, and the executable program is a DCOM executable server. This figure shows how multiple application programs may share a single video camera. Once a first application program 100 calls to connect to the video camera 108, the call is passed to the DCOM application program interface (API) 102. The appropriate Microsoft documentation or the Microsoft website may be referred to for a more detailed description of DCOM. The DCOM API 102 handles the loading of the DCOM executable program and establishes a connection from the application program to the DCOM executable program 200. The DCOM server 200 creates a single video camera instance 106 and a first MIIDC instance 104. Next, the DCOM server 200 connects the single video camera instance 106 to the video camera driver 107, the video camera driver 107 to the video camera device 108 and the first MIIDC instance 104 with the single video camera instance 106. The video camera instance 106 is a virtual interface to the physical video camera device 108. An instance is an actual usage and the virtual creation of a copy of an entity loaded into memory. In this embodiment all instance memory is allocated in the executable server. Finally the connection 300 is established allowing client application 100 to interact through the newly instantiated DCOM interface (single video camera instance) 106 with the video camera device 108.

Once a second application program 110 calls to connect to the video camera 108, the DCOM server 200 creates a second MIIDC instance 114, and connects it to the single video camera instance 106 thus allowing the second client application 110 to interact through the single video camera instance 106 with the video camera device 108 via the second established connection 310. Subsequent application program calls 120, et. seq. also interact through the DCOM instantiated single video camera instance interface 106 with the video camera device 108 via the subsequently established connections 320, et seq.

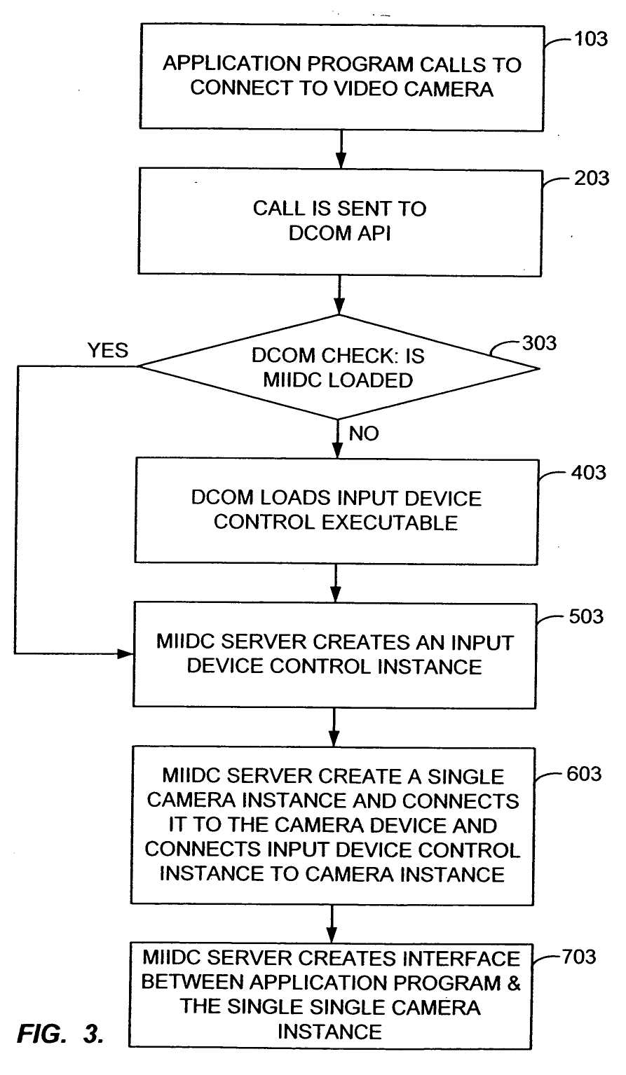

FIGS. 3 is a flowchart depicting the process of FIG. 2. Once a client application program calls to connect to the video camera device (step 103), the application program's call is sent to the DCOM API (step 203). Next, the DCOM API determines whether the DCOM implemented MIIDC executable is loaded or not. Typically the first client application program causes the MIIDC executable to be loaded. If the MIIDC executable server is not loaded, the DCOM API takes the call and causes the DCOM server to load the DCOM implemented MIIDC executable server (step 403). Next, the MIIDC server creates an input device control instance (step 503). If the MIIDC executable server had already been loaded, step 403 becomes unnecessary, and the next step after step 303 would be step 503. The MIIDC server next creates a single video camera instance and connects it to the video camera device, and connects the input device control instance to the single video camera instance (step 603). Finally, the MIIDC server creates an interface through which the first client application program communicates with the single camera instance (step 703).

The video camera instance 106 depicted on FIG. 2 is an interface with the video camera device that maintains the state of the input device control's instance. The input device instance 106 is a block of memory that maintains the necessary accounting of the number of connections that have been established with the video camera device, and the particular states of each of these connections. The video camera instance 106 also incorporates the logic necessary to prioritize the requests from each input device control instance connection and multiplex and resolve conflicting requests. Since the MIIDC server exists as a separate process, video (and audio) data must be replicated for each client requiring access to the video (and audio) data. To reduce data replication, the MIIDC server is designed to record video (and audio), detect motion, save pictures, as well as other functions which are typical of a media source capture device. The MIIDC server thus limits the data replication to only those applications requiring direct access to media source (e.g., video and audio) data.

For example, the first input device instance may be requesting a video stream having a resolution of 640 by 480 pixels, while the second and third instances may be requesting video streams having 320 by 480 and 160 by 120 pixel resolutions respectively. In such a scenario, the video camera instance 106 would then decide to capture video at the largest resolution of 640 by 480 pixels and then scale it or crop it down to the lower resolutions being requested by the second and third instances. Following the same logic, if consequently the first video instance disconnects from the video camera, the video camera instance 106, would then resolve the requests from the second and third instances requesting 320 by 480 and 160 by 120 pixel resolutions respectively, by capturing video at the highest requested resolution of 320 by 480 pixels to satisfy the second instance's request and then scaling down or cropping the 320 by 480 pixels video stream down to 160 by 120 pixels to satisfy the third instance's request.

In another example involving three input device control instances, the first input device control instance may be sending a motion detection command to the virtual video camera device, while the other two instances are only requesting video streams. Now the video camera instance 106 would capture video at the highest demanded resolution and only pass that video stream through a motion detection calculation for the first input device control instance.

In yet another example involving three input device control instances, the second input device control instance may be requesting a text overlay on the video image, while the other two instances are only requesting video stream captures. Now, the video camera instance 106 would capture video at the highest demanded and only add the text overlay to the stream flowing to the second input device request.

While the embodiments described thus far were generally described in the context of a video camera that is interfaced with a personal computer host, the scope of the present invention is not meant to be limited solely to a video camera or even a particular type of personal computer host. As described above, the embodiments of the present invention are directed towards the simultaneous sharing of an input device by several application programs by virtualizing a device driver file which is in turn achieved by implementing the input device control program as an executable server. While the input device described above is a video camera, another input device that can be configured to be simultaneously shared is a microphone. Thus, the input device instance (106 on FIG. 2) incorporates the logic necessary to prioritize the requests from each input device control instance and multiplex and resolve conflicting requests. Extending the sharing capabilities of video source to also include an audio input source, is not only a natural one, but it is also almost mandatory, since video and audio are most commonly bundled together as naturally complementary media sources.

For example, referring back to FIG. 2, it is expected to consider that a microphone (not shown) is also recording sound while the device 108 is recording video. Then for example, the first input device instance may be requesting audio having a bit depth of 16-bits at 44.1 kHz, while the second instance may be requesting audio streams having an 8-bit depth at 11.025 kHz. In such a scenario, the input device instance will then decide to capture audio at the highest sampling rate and bit depth and then scale, or compress it down to the lower bit depth or sampling rate being requested by the second instance.

The MIIDC and the method of virtualizing an input device are implementable on many computing platforms running various operating systems. A media source input device such as a video camera or a microphone is commonly interfaced with a host computer. The host computer is most commonly a personal computer, such as the commonly available PC of Mac computers. However, since advancements in technology are blurring the boundaries between computing and communication devices, a host computer as used herein is synonymous with an intelligent host, and an intelligent host as used herein is meant to include other examples of any host having a processor, memory, means for input and output, and means for storage. Other examples of intelligent hosts, which are also equally qualified to be used in conjunction with embodiments of the present invention include a handheld computer, an interactive set-top box, a thin client computing device, a personal access device, a personal digital assistants, and an internet appliance.

Other aspects of the present invention are directed towards the client-side mechanisms that enable an application program to communicate with the input device server executable. As described above, the MIIDC executable is implemented under a client-server architecture, where each application program is a client. Therefore, a client must be able to communicate with the server. The method of the present invention provides several mechanisms that enable an application program to communicate with the MIIDC server. In a PC/Windows environment, a first client-side mechanism is delivered via an ActiveX control called an input device portal. A second client-side mechanism also under a PC/Windows environment, is delivered via a DirectShow video capture source filter.

The client side mechanisms under the portal approach include communicating with the MIIDC server and supplying user-interface elements to an application. With the portal approach, all functionality of virtualizing an input device is performed by the MIIDC server, and thus, application programs communicating with the MIIDC server will require user-interface programming. To accomplish this, under the video-portal approach, a template is provided to allow various application program providers to generate their own custom input-device portal.

The client-side mechanism under the second approach (i.e. DirectShow approach) takes advantage of the standardized DirectShow modular components called filters. DirectShow™ services from Microsoft™ provide playback services for multimedia streams including capture of multimedia streams from devices. At the heart of the DirectShow™ services is a modular system of pluggable components called filters.

These modular components can be classified as a source, transform or renderer. Filters operate on data streams by reading, copying, modifying or writing the data to a file or rendering the file to an output device. The filters have input and output means and are connected to each other in a configuration called a filter graph. Application programs use an object called the filter graph manager to assemble the filter graph and move data through it. The filter graph manager handles the data flow from an input device to the playback device. A further description of DirectShow™ services and the Microsoft™ DirectX™ media software development kit can be obtained by referring to appropriate documentation as is known to those of skill in the art.

This second client-side mechanism replaces the standard source (media input) filter with a virtual source filter, which communicates directly with the MIIDC server. The virtual source filter is a client to the MIIDC server. With this mechanism, a DirectShow application cannot distinguish between the “real” and the “virtual” source filter. The advantage of this second client-side mechanism is that any application program written to function in a DirectShow environment, will be able to readily share an input device without the need for any additional user-interface programming before being able to communicate with the MIIDC server.

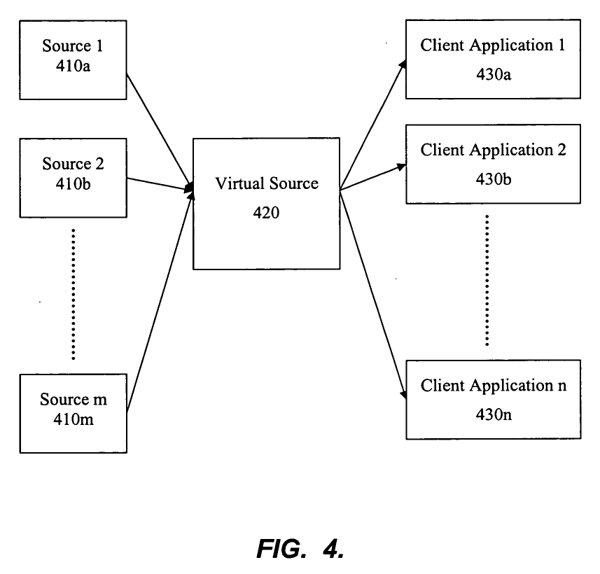

FIG. 4 is a block diagram which illustrates an embodiment of the present invention, in which video and other media data from one or more sources can be provided to one or more applications. The block diagram includes media data sources 410, media data client applications 430, and a virtual source 420.

Several sources 410a, 410b, . . . , 410m, can provide multimedia data. These sources of data can be data capture devices which can capture some type of multimedia data (e.g., video, and/or still image). Examples of sources 410 of the multimedia data include peripheral devices such as microphones, stand-alone video cameras, webcams, digital still cameras, and/or other video/audio capture devices. In one embodiment, some of the sources 410 are QuickCam® webcams from Logitech, Inc. (Fremont, Calif.). The data may be provided over a wireless connection by a Bluetooth™/IR receiver, Wireless USB, or various input/output interfaces provided on a standard or customized computer. The data stream may be dispatched to a data sink, such as a file, speaker, client application or device.

Several client applications 430a, 430 b, . . . , 430n, need to use the data provided by sources 410. The client applications 430 can be any consumer that is a client to the source(s) 430. In one embodiment, some of the client applications 430 are Instant Messengers (IM). Some examples of currently available IM programs are MSN® Messenger from Microsoft Corporation (Redmond, Wash.), America OnLine Instant Messenger (AIM) from America Online, Inc. (Dulles, Va.), and Yahoo!® Instant Messenger from Yahoo! Inc. (Sunnyvale, Calif.). In another embodiment, some of the client applications 430 are Video Conferencing applications, such as NetMeeting from Microsoft Corporation (Redmond, Wash.). In one embodiment, some of the client applications 430 are playback/recording applications such as Windows Media Player from Microsoft Corporation (Redmond, Wash.), communications applications such as Windows Messenger from Microsoft Corporation (Redmond, Wash.), video editing applications, or any other type of general or special purpose multimedia applications.

The virtual source 420 connects to the source(s) 410 and requests data from it (them). The virtual source 420 then processes, clones, and formats this data as necessary before providing a stream to the client application(s) 430.

In one embodiment, the virtual source 420 is created on a host (e.g., a computer system) to which the sources 410 are attached, and on which the client applications 430 reside. In one embodiment, the virtual source 420 is created in the kernel mode. In one embodiment, the virtual source 420 allows for complete transparency of the sources 410 from the client applications 430. The sources 410 are completely hidden from the client applications 430, and the client applications 430 are thus completely unaware of the existence of the sources 410. The client application call to the desired media device (camera, etc.) is basically routed to the virtual device of the invention, which registers itself on the system bus as the desired device. A WDM bus enumerator is attached to the root bus. This enumerator is thus itself enumerated at boot time (or at install time) by the operating system with all the other root enumerated devices. This enumerator is in charge of managing a bus of virtual devices to do so, it monitors the arrival and departure of the physical devices that are to be virtualized and enumerates a virtual device for each physical device it finds.

In other words, a client application 430 cannot tell that it is communicating with anything other a regular source. Further, the user also cannot tell that he/she is interacting with a virtual source 420. The user does not need to choose any alternate virtual device in order to use a system in accordance with an embodiment of the present invention. Rather, the user's experience is totally seamless and transparent.

In one embodiment, the client application(s) 430 remain completely unaware of the original format/content of data streams from the data source 410. A system in accordance with an embodiment of the present invention can thus accept a variety of formats and content. In one embodiment, the frame rates and/or formats requested by the client application(s) 430 are not supported by the underlying source(s) 410. The video driver of the invention sends control signals to select the desired format and other controllable features of the physical camera. For example, the highest resolution and frame rate that any client is requesting can be set, so that the virtual driver may generate lower frame rates and resolutions for other clients requesting those different values. Other parameters can be varied from client to client, such as electronic focus, pan and tilt.

The data stream may be in any of a variety of formats. For example, video streams can be compressed or uncompressed, and in any of a variety of formats including RGB, YUV, MJPEG, various MPEG formats (e.g., MPEG 1, MPEG 2, MPEG 4, MPEG 7, etc.), WMF (Windows Media Format), RM (Real Media), Quicktime, Shockwave and others. Finally, the data may also be in the AVI (Audio Video Interleave) format.

In one embodiment, the virtual source 420 assesses and determines the most suitable format in which to obtain data from the sources 410 in order to provide the data to the client applications 430. In one embodiment, the client applications 430 request different formats and/or frame rates, and the virtual source 420 can satisfy the request of each client application 430. In one embodiment, multiple video streams from various sources 410 are combined into one virtual stream from the virtual source 420 that can then be accessed by one or more client applications 430, each client potentially requesting a different format and frame rate.

In some embodiments of the present invention, the implementation will work only with specific sources, and not with others. For instance, an implementation in accordance with an embodiment of the present invention may work only with webcams from a specific supplier, but not with webcams from other suppliers. In one embodiment, an encrypted handshake is used with the sources (devices to be virtualized), such that only certain sources can be used in this manner.

In one embodiment, multiple video sources can be provided to an application which will display them side by side, or in separate viewing windows. For example, multiple cameras may be monitored for security applications, with a mosaic of different camera images displayed. Alternately, two images sensors from a single camera may be used to capture essential the same view. One image sensor may be a low resolution sensor for video or motion detection, while another sensor may be a high resolution sensor for still images. Alternately, images taken from different positions in a camera, or from multiple cameras, can be used to construct a 3-dimentional (3D) image or video. The 3D image could be constructed either in the driver, or in the client application. In another embodiment, images may be superimposed on one another, either in the driver or the client application. This may be done, for instance, to put a different background behind a person.

As will be understood by those skilled in the art, the present invention may be embodied in other specific forms without departing from the essential characteristics thereof. For example, still image data could be manipulated in various embodiments of the present invention, instead of, or in addition to, video and audio data. These other embodiments are intended to be included within the scope of the present invention, which is set forth in the following claims.

What is claimed is:

1. A system for transparently providing multimedia data to a plurality of client applications, the system comprising:
a data source which provides the multimedia data;
a first client application which uses the multimedia data;
a second client application which uses the multimedia data;
a virtual data source communicatively coupled to the data source and the first and
second client applications, wherein the virtual source obtains the multimedia data from the data source, and provides the multimedia data to the first client application and the second client application.

2. The system of claim 1, wherein the multimedia data is video data.

3. The system of claim 2, wherein the data source is a webcam.

4. The system of claim 1, wherein the first client application is an instant messaging application.

5. The system of claim 1, wherein the virtual source is located in the kernel mode.

6. The system of claim 1, further comprising:
a second data source, communicatively coupled to the virtual source, wherein the first client application receives a single data stream combining data from the first data source and the second data source.

7. The system of claim 1, wherein the first client application requests a format of data different from the format of data provided by the data source.

8. The system of claim 7, wherein the virtual source determines the format of the data to be received from the data source in order to enable efficient creation of the format of the data requested by the client application.

9. The system of claim 1, wherein the first client application requests a frame rate of data different from the frame rate of data provided by the data source.

10. A system for transparently providing multimedia data from a plurality of data sources to a client application, the system comprising:
a first data source which provides first multimedia data;
a second data source which provides second multimedia data;
a virtual data source communicatively coupled to the first data source and the second data source and to the client application, wherein the virtual source obtains the first multimedia data from the first data source and the second multimedia data from the second data source, and provides a single data stream combining the first multimedia data and the second multimedia data, to the client application.

11. A method for providing multimedia data to a plurality of client applications, wherein the multimedia data is provided by a data source, where the processing is transparent to the plurality of client applications, the method comprising:
obtaining, by a virtual source, the data provided by the data source;
modifying one of the frame rate or the format of the data; and
providing the modified multimedia data to each of the plurality of client applications.

12. The method of claim 11, wherein the multimedia data is video data.

13. The method of claim 11, wherein the multimedia data is still image data.

14. A method for transparently providing multimedia data from a plurality of data sources to a client application, the method comprising:
obtaining, by a virtual source, the first multimedia data from the first data source;
obtaining, by the virtual source, the second multimedia data from the second data source;
combining the first multimedia data and the second multimedia data to create a single data stream; and
providing the single data stream to the client application.

15. The method of claim 14 wherein the first multimedia data is a first video image from a first image sensor in a camera and the second multimedia data is a second video image from a second image sensor in said camera.

16. The method of claim 15 wherein first video image is low resolution and said second video image is high resolution.

17. The method of claim 14 further comprising creating a three dimensional image from said first and second video images.

18. A computer useable medium including a computer program for causing the simultaneous sharing of an input device, said program comprising, code for invoking an input device control program in response to a first access request received from a first application program requesting access to said single input device;
code for associating a single input device instance to said single input device upon creating said single input device instance according to said input device control program;
code for generating a first control instance in response to said first request, said first control instance being associated with said first application program;
code for associating said first control instance to said single input device instance, so that said first application program can access said single input device using said association between said first control instance and said single input device instance;
code for generating a second control instance in response a second access request received from a second application program requesting access to said single input device; and
code for associating said second control instance to said single input device instance, so that said second application program can access said single input device using said association between said second control instance and said single input device instance
